(19) United States
(12) Patent Application Publication
(10) Pub. No.: US 2007/0112609 A1
(43) Pub. Date: May 17, 2007

(54) METHODS AND APPARATUS TO INCORPORATE USER FEEDBACK DURING PLANNING

(76) Inventors: Michael D. Howard, Westlake Village, CA (US); Peter A. Tinker, West Hills, CA (US); Eric Huang, Los Angeles, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/554,667

(22) Filed: Oct. 31, 2006

Related U.S. Application Data
(60) Provisional application No. 60/737,149, filed on Nov. 16, 2005.

(51) Int. Cl. G06F 9/46

(52) U.S. Cl. 705/8

(57) ABSTRACT

Methods and apparatus to incorporate user feedback during planning. In one embodiment, first and second plans are generated for which user feedback is obtained and used to generate a revised plan.

### CROSS REFERENCE TO RELATED APPLICATIONS

The present application claims the benefit of U.S. Provisional Patent Application No. 60/737,149, filed on Nov. 16, 2005, which is incorporated herein by reference.

### BACKGROUND

As is known in the art, there are a variety of known planner systems to enable a user to generate a plan having a series of actions to achieve a goal. For example, the BBN Cadet (Course of Action Development & Evaluation Tool) is a mature brigade-size land maneuver planner. The user edits knowledge templates to change the planning behavior. A knowledge template is a form that describes rules. However, the BBN Cadet system does not provide a way to indicate how a new rule will interact with existing rules. The CAPES (Combined Arms Planning and Execution Monitoring System) is a combination of several well-developed parts such as a OneSAF simulator, a FOX-GA genetic COA generator, and a DAVINCI map view with limited integration. CAPES does not have a planner per se; FOX-GA is only a planning aid that can get a rough plan by doing very high-level war-gaming. To influence FOX-GA, the user would have to change its evaluation function, which would require a very highly sophisticated and technical user, which may not provide a practical system.

In U.S. Pat. No. 5,940,816, entitled “Multi-objective decision support methodology,” the Abstract states “[a] method for effecting computer implemented decision support. The method can improve on a candidate solution by allowing problem solving methods to cooperate towards the creation of a more desirable solution. The method can realize an enhanced understanding of tradeoffs inherent in competing objectives, and can incorporate factors or special considerations not easily specified, by enabling the decision maker to actively participate in the creation of a more desirable solution.”

The '816 patent describes a decision support approach to helping a user improve a plan, but does not use a planner to help the decision support system focus the user on important problem areas. The '816 patent discloses creating a set of candidate plans, such as on a set of CPUs, and teaches displaying the candidates to the user, possibly ordered by a weighted sum of metrics. The '816 patent discloses that the user can dynamically interact with the set of candidate solutions, possibly editing them. Eventually the user chooses one. However, the only way the user can influence the generation of plans is to edit a plan and put it back in the population. This method relies on agents creating enough of a variety in the population of solutions that one will be acceptable. The approach is similar to a Genetic Algorithm, in that there are improver agents that can randomly combine solutions to create hybrids. However, this system offers no way for the user to express feedback on which parts of plans are good.

As is known in the art, deliberative decision-making often relies on a plan: a sequence of parameterized actions that lead from an initial state to a desired goal state. Because of the enormous computational complexity of planning, modern planners have developed heuristic search techniques that can generate a plan in reasonable time. But it is difficult to represent real-world problems in enough detail for planners to create a plan that makes sense to users. It is also difficult to recognize and represent the types of intuitions and heuristics that experts use when planning in the real world. The “holy grail” of planning/decision support is to use the computer to crunch mind-numbing details, but ask the user to employ human pattern recognition, experience, and intuition when appropriate. Incorporating users into the process can be relatively difficult. Even deciding what parts of a particular problem humans can do better than automated planners can require some intuition.

### SUMMARY

The present invention provides methods and apparatus to enable a planner to generate multiple plans so that users can choose from several options for achieving goals. It will be readily appreciated that an ability to generate and compare multiple plans is desirable for a decision-making system. In an exemplary embodiment, the user can provide feedback that can influence the planner the next time it plans or replans. In one particular embodiment, feedback is provided by obtaining user ‘likes’ and ‘dislikes’ about actions in the plans presented, storing that information in the planner, and generating another plan or set of plans using that information.

In one aspect of the invention, a planner is directed as to how to obtain user choices for influencing the planner using an exemplary mechanism. In one embodiment, a decision support system is linked with a planning system that can choose actions to support goals while optimizing a given metric. The planner can store and retrieve information about previously generated plans; it uses this information to learn how to create better plans, and to guide its planning after this training process. Illustrative types of information are defined below that the planner stores while planning for training and later for runtime use with exemplary data structures that can be used to capture that information. They describe how the stored information is used during runtime to influence the planning process, resulting in plans that reflect user preferences.

In one aspect of the invention, there is ‘close’ coordination of a fast planner and a Decision Support System (“DSS”) that supports production of multiple related plans and enables their comparison. If the planning process is fast enough that the user is not fatigued waiting for a plan, a user can request multiple plans and use the DSS in a mixed-initiative mode, giving feedback and asking the planner to replan based on the feedback. In one embodiment of the invention, a method provides for obtaining user feedback and using it to influence subsequent replans by the planner. The method includes creating one or more plans using different settings for the weights of the planner's evaluation function. These plans are presented to the user, and the user indicates sections of each plan that are good or desirable. A section of a plan is a subset of sequential actions. The DSS then communicates to the planner a list, for each plan, comprising each action or set of actions that was indicated, and the user feedback (e.g., a binary ‘good’ or ‘bad’ rating). Since each plan was created to optimize a certain value of weights for the evaluation metric, ‘good’ means that the planner should reinforce those weighting values in those situational contexts. ‘Bad’ means to avoid those weighting values in those contexts.

In one embodiment, the planner updates a table of evaluation metric weights for different situational contexts. Then, when the planner replans, any time it finds itself in a context that is referenced in that table; it can use the prescribed weights in its action evaluation function. The result is a new plan that incorporates the user's feedback.

In one aspect of the invention, a method includes generating a first plan having a series of actions, outputting the plan to enable a user to perceive the plan, receiving feedback from the user on the plan, and generating a revised plan based upon the first plan and the feedback from the user.

The method can further include one or more of the following features: the user feedback includes a portion of a plan selected by the user, the selected portion corresponds to a portion of the plan liked by the user for at least one of the series of actions, the user feedback is stored for use in generating subsequent plans, the records are indexed by a function of a list of facts that describe a situation, the index further incorporates a list of subgoals, the records include a list of weights for parameters of an evaluation function for rating actions, and comparing a new state of the plan to a state in a database of user preferences.

In another aspect of the invention, a method includes generating first and second plans, outputting the first and second plans to enable a user to perceive the first and second plans, processing user feedback on the first and second plans, and combining the first and second plans to provide a revised plan based upon the user feedback.

The method can further include one or more of the following features:

dynamically altering weights of an evaluation function to incorporate the user feedback in the revised plan, generating the first plan by tasking a planner with a set of weights for an evaluation function and problem specification files, the weights are multipliers in a linear combination of factors used by the evaluation function when rating an action for incorporation into the revised plan, the first and second plans are generated by using first and second weightings that are different, the first weightings are obtained from a user history file, and the first weightings are created randomly,

### BRIEF DESCRIPTION OF THE DRAWINGS

Features of this invention, as well as the invention itself, may be more fully understood from the following description of the drawings in which:

FIG. 1 is a diagram showing interaction in a system incorporating user feedback in accordance with exemplary embodiments of the invention;

FIG. 2 is a block diagram of a system incorporating user feedback in accordance with exemplary embodiments of the invention;

FIG. 3 is a flow diagram showing an exemplary sequence of steps to provide incorporation of user feedback on a plan in accordance with embodiments of the invention;

FIG. 3A is a flow diagram showing additional details for user feedback; and

FIGS. 4-10 show an example of planning with metric evaluation weights dynamically changed in accordance with exemplary embodiments of the invention.

### DETAILED DESCRIPTION

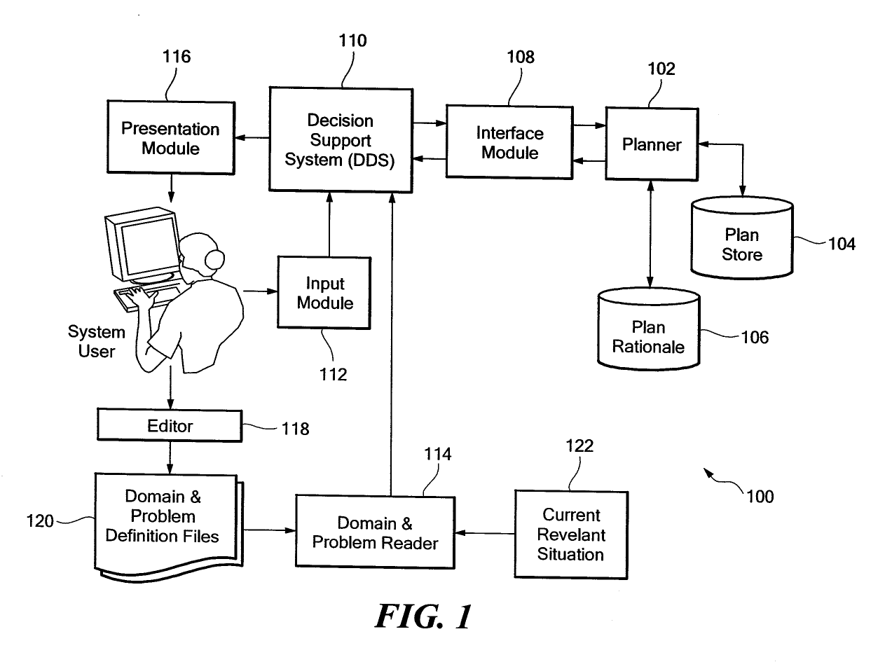

FIG. 1 shows an exemplary system 100 including a planner 102 for incorporating user feedback on a plan in accordance with exemplary embodiments of the invention. In general, the planner 102 solves goals incrementally by applying actions to a plan until goals are achieved and action preconditions have been supported either by the initial state or by the effects of other actions. In one embodiment, a Decision Support System (DSS) 110, which provides a user interface into the system, tasks one or more planners 102 to create plans, each employing a different set of weights on an evaluation function.

It is understood that the term “planner” refers to hardware and/or software to implement modules tasked to plan a set of actions to achieve assigned goals. In one embodiment, the planning processes run on the same processor. In other embodiments, multiple processors are used.

In the illustrated embodiment, the planner module 102 is coupled to a plan store database 104 and a plan rationale database 106. An interface module 108 provides an interface between the planner and the decision support system (DSS) 110. A user provides input to the DSS 110 via an input module 112. The DSS also receives input from a domain and problem reader 114. The DSS provides information to a presentation module 116 for generating a display from which a user can see and understand the plan. The user can use an editor 118 to modify domain and problem definition files 120, which are input to the domain and problem reader 114. A current relevant situation module 122 provides information to the domain and problem reader 114, such as the state of dynamically changing variables.

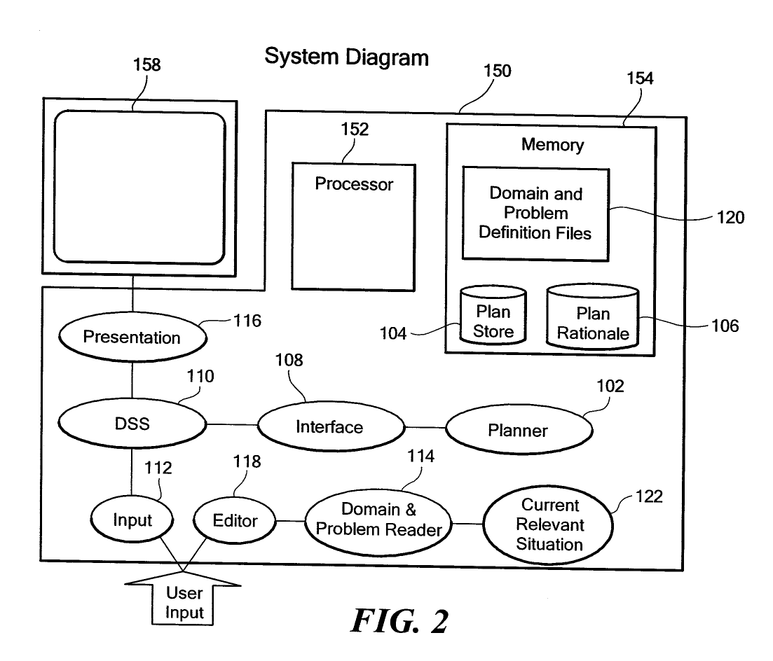

In an exemplary embodiment shown in FIG. 2, the planner module 102 is a process running on the same workstation 150 and processor 152 as the DSS 110. In an alternative embodiment, the planner module 102 runs as a service on a different machine. The workstation 150 includes memory 154, one or more CPUs, and an operating system 156 under which the planner and DSS operate. A workstation display 158 provides a means for the user to view the plan.

The interface module 108 performs data and command translation between the planner and DSS modules 102, 110 and can also buffer/connect if the modules are on different machines. The presentation module 116 generates display information to enable the plan to be represented on the user's display device. As described more fully below, the presentation module 116 can include mechanisms for enabling a user to explore the plan and ask for rationale on decisions made by the planner module 102.

The input module 112 interprets user interactions with the display as commands to the DSS module 110. The DSS 110 may in turn cause the presentation module 116 to alter the display to obtain or present more information from the user. The domain and problem definition files 120 are communicated to the DSS 110 initially by means of the domain and problem reader module 114, which may employ a variety of ways to get the information. In one embodiment, the user edits definition files in a structured format, such as the PDDL2.1 format currently in use by the International Planning Competitions.

Current relevant situation information 122 is the current state of dynamically changing variables, such as the locations of objects relevant to the plan, current levels of numeric resources such as fuel, etc. This can be provided by analysts, filtered by some automated or human agent and used to update the system tasking.

The planner module 102 can be implemented in a variety of configurations. Various functional partitions between hardware and software will be readily apparent to one of ordinary skill in the art.

It is understood that the planner 102 may be tightly integrated with the DSS 110 as a module, or may be loosely connected, such by a web service. Interfaces to achieve the desired configuration are well known in the art.

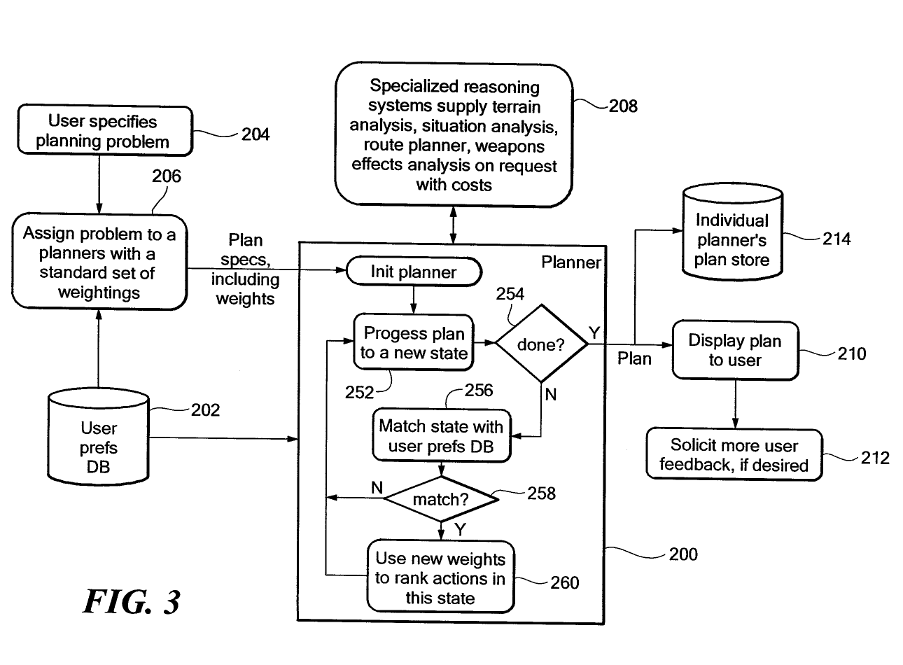

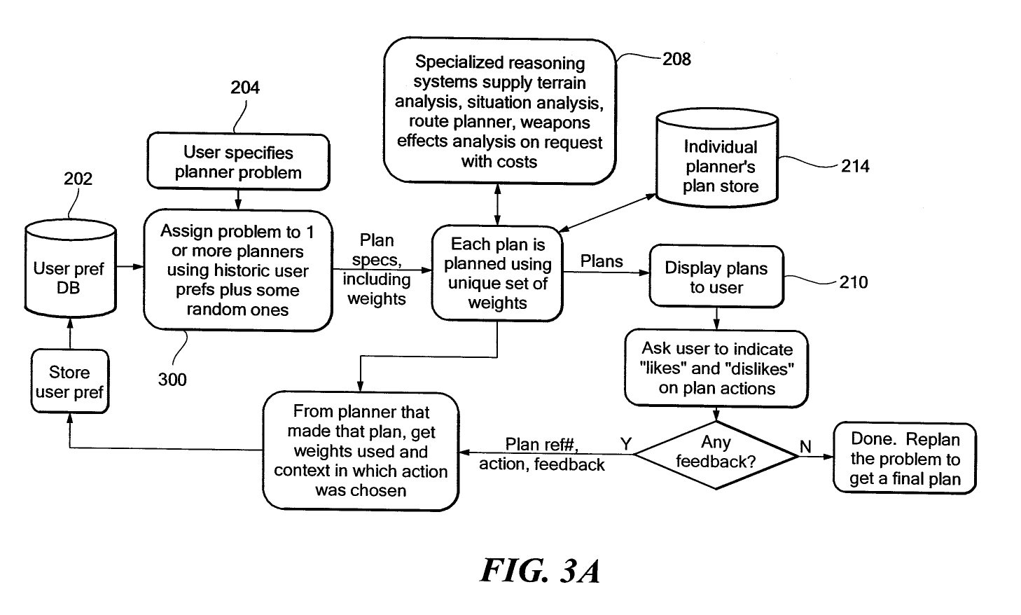

FIG. 3 shows exemplary interaction with a planner 200 to provide user feedback on a plan in accordance with exemplary embodiments of the invention. In one embodiment, the planner 100 solves goals incrementally by applying actions to a plan until goals are achieved and action preconditions have been supported either by the initial state or by the effects of other actions.

Initially, a user specifies a planning problem 204 that is assigned to one or more planners 200 with a set of weightings 206. Weightings can be provided by the user preferences database 202 before the plan and weights are provided to the planner 200. If the user preference database 202 has not yet been populated, a unique set of weights for each planning problem is generated either randomly or using a default spanning set of weights. As discussed in more detail below, reasoning systems can supply terrain, situation analysis, route planning, weapons analysis, and other information with associated cost information 208.

The planner 200 receives the plan information for processing by an initial planner module 250. The planner iteratively applies an action to a plan, each time progressing the plan to a new state 252. If the plan is not complete, it looks in the user preferences database 202 for a match with the new state 256. If it finds a match 258, it uses the new weights associated with that state to rank actions that can be added to the plan 260, and applies the highest ranked action, progressing the plan to a new state 252. This process continues until the problem goals have been achieved, or the goals are determined to be unachievable, or the goals are partially achieved and the planner cannot achieve the rest. The decision of when the planner has done all it can may vary between planners. When the planner determines that the plan is complete 254, the plan is output for display to a user 210. Further user feedback for the displayed plan can optionally be solicited 212. The plan can is stored by a particular planner 214, and will be used later if the user provides feedback on a section of that plan.

In one embodiment, the planner 200 supports either forward searches or backward searches. The planner 200 determines which action to apply at each particular situational context encountered during the planning process. In an exemplary embodiment, a situational context, usually called a “state”, comprises the values of Boolean facts and numeric variables at a certain stage of the plan. The evaluation metric is a weighted combination of two or more evaluation criteria; e.g., a linear weighted sum. In an exemplary implementation, the criteria are the “makespan” (length of the plan), threats or actions in the current plan that may conflict with the proposed action or actions that the proposed action may require, and a metric value that indicates cost/benefit tradeoff of adding the action. It is understood that a wide range of criteria may be used. It is further understood that the inventive system does not require any particular set of factors in the evaluation module. In one embodiment, the values of each criterion in the evaluation module are evaluated based on a simulation of the results of adding that action to the plan. The simulation, known as a “relaxed plan,” is known to those skilled in the art; e.g., the LPG planning system uses a relaxed plan in its evaluation function to evaluate each proposed action before choosing one to add to the plan. A relaxed plan is a set of actions required to make the current plan consistent, without considering conflicts (known as mutual exclusions) between the actions.

In general, the weights weigh the importance of each factor in choice of each action considered for adding to the plan. As noted above, a set of weights is associated with a ‘situational context.’ In general, a situational context is a description of a state in the plan, at a point in the plan where the planner is currently working. In one implementation, each state in the plan is described by a unique value of a set of facts that describe the situation. By the frame axiom, which is well known to those skilled in the art, the planner considers the world fully described by the set of facts given in the problem description. In forward search planning, an action may be considered for operation in a situational context or “state” when its preconditions are satisfied in the state, and when applied the state is modified as the action description specifies. In reverse search planning, an action is considered when its effects match the state, and when applied the state is modified according to the action's preconditions. In either case, we associate a state with a set of weights to be used when evaluating actions for addition to the plan.

As the planner 200 is constructing the plan, if it finds that the current state in the plan matches a state in the user preferences database 202, then the planner can change the current evaluation metric weights while it is evaluating actions to add to apply in that state. The user preferences database 202, which can be provided as a table of weights for different situational contexts, can be implemented by an analogical reasoner, such as the SAGE. The analogical reasoner can apply ontological knowledge of the domain to find situational contexts that are relatively close, but not perfect matches to the current state in the plan. By using SAGE, for example, for storage and retrieval of the user feedback, the inventive embodiments can generalize the situational context from the current grounded set of plan variables to types of objects in the situation.

In one aspect of the invention, the planner dynamically adapts an evaluation module during planning in response to user preferences for certain situations. The term “dynamically adapts” refer to changing the weights dynamically during planning, if the current planning state matches 256 one in the user preferences database 202. After an action is chosen for the state using the weights found in the user preferences database 202 for that state, the planner returns the weights to the default values, the action is applied to the plan, changing the state, and the planning process continues. That is, the plan is progressed to a new state 252.

The exemplary embodiments provide an inventive way to elicit user feedback for incorporation into planning. Few decision support systems work closely with a planning system of any kind; we are aware of only one of those that allows a non-technical user to influence the planner. That planner, BBN's CADET (L. Ground, A. Kott and R. Budd (2002). A Knowledge-Based Tool for Planning of Military Operations: the Coalition Perspective, BBN Technologies, Pittsburgh, Pa., http://www.aiai.ed.ac.uk/project/coalition/ksco/ksco-2002/pdf-parts/Z-ksco-2002-paper-10-ground.pdf), requires editing rules or templates that guide the planner.

FIG. 3A shows further details for capturing user preferences for a plan and converting them into directions to the planner in accordance with exemplary embodiments of the invention. FIG. 3A has some commonality with FIG. 3 where like reference numbers indicate like elements.

When the user specifies the planning problem 204, the system arranges for the problem to be planned more than one time, each time using a different set of weights for the evaluation metric 300. The first time a user uses the system, the sets of weights chosen for each plan might be the result of a random sampling of the range of each weight (sometimes called “parameter sweeping”) or otherwise generated set of default values, or might be a representative set previously learned from a set of similar users in a similar problem domain.

The user annotates each plan with feedback. The preferred implementation for eliciting user likes and dislikes is to present the plans graphically on the computer screen, asking users to indicate parts of the plan that are “good” or “liked” in the sense of achieving the user's goals in a desirable way, and parts that are “bad” or “disliked”, meaning that they do not achieve the user's goals or they achieve them in an undesirable way. For example, a plan that involves actions that are geographical movements might be represented by labeled arrows on a map, labeled to indicate times and resources involved. The system could obtain the user feedback by asking the user to indicate with a mouse pointer features that are “good” and “bad”. Any feature not indicated might not be reinforced by the system, or optionally could be considered “good” by default.

Given this type of feedback on the plans, the planner then makes a new plan that incorporates that feedback. In an exemplary embodiment, the descriptions used here (“good,” “bad,” etc) are deliberately fuzzy because the purpose is to elicit human intuition and lateral thinking that a standard planning system cannot emulate. The user may not be able to communicate a logical rationale for why an action is good or bad—he simply “knows.” This is an advantage of the inventive system. User feedback is obtained in a very natural way using a convenient representation of a particular plan, rather than indirectly by editing rules. The user requires no knowledge of the workings of the planner.

In general the meaning of “like/good” or “dislike/bad” may mean different things to different users in different problem contexts. Action preference feedback is interpreted in the context of the state that exists at the time each action is being chosen for the plan. Normally, a planner keeps such information private and discards it when the plan is finished. In the inventive system the planner saves internal action selection criteria information and can access it on request when the user expresses preferences. When a user expresses a reaction that an action in a particular plan is “liked,” the system looks up the weights that were in effect when that action was chosen, and associates it with the situational context that was active when the action was chosen. This association between a state and a set of weights is stored in the user preferences database. If the user expressed a reaction that an action in a plan is “disliked,” the state is associated with the weights that were in effect when the action was chosen, and stored in the user preferences database as undesirable. The process of storing user feedback in the user preferences database is discussed below.

The inventive mechanism of associating states with weightings on the evaluation metric, and using those weights when replanning, adapts the planner action evaluation function to implement user preferences, and in the process the system can learn persistent information about user preferences that is available the next time that user requests a plan.

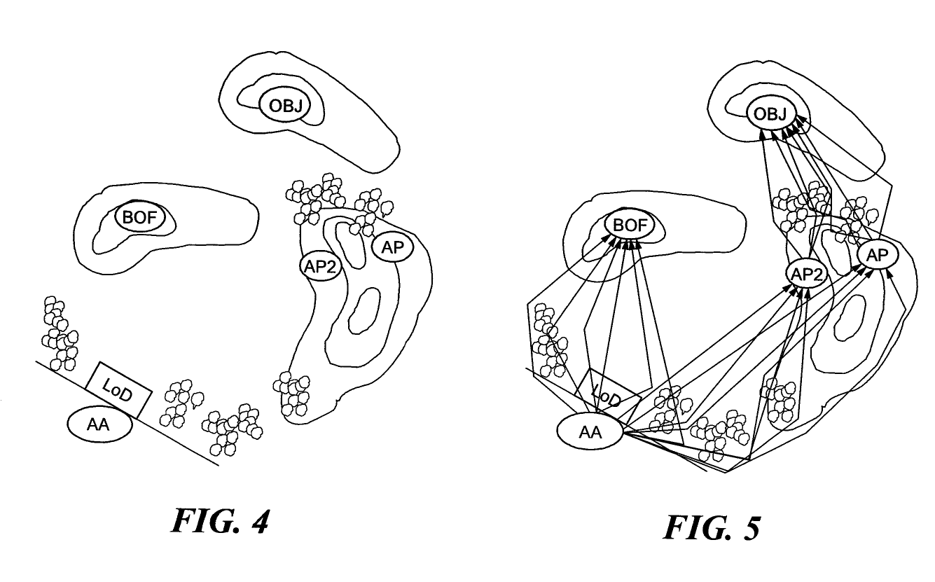

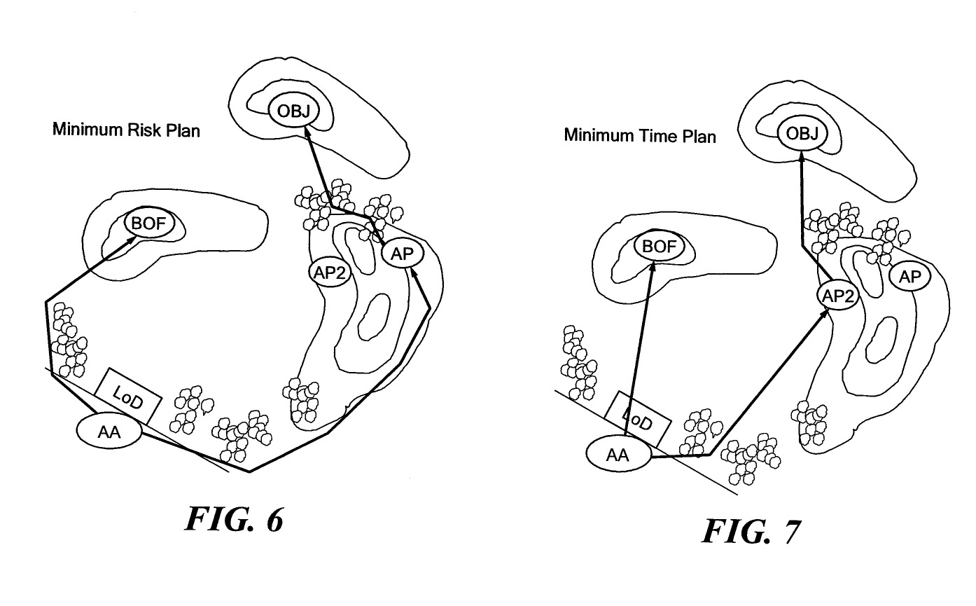

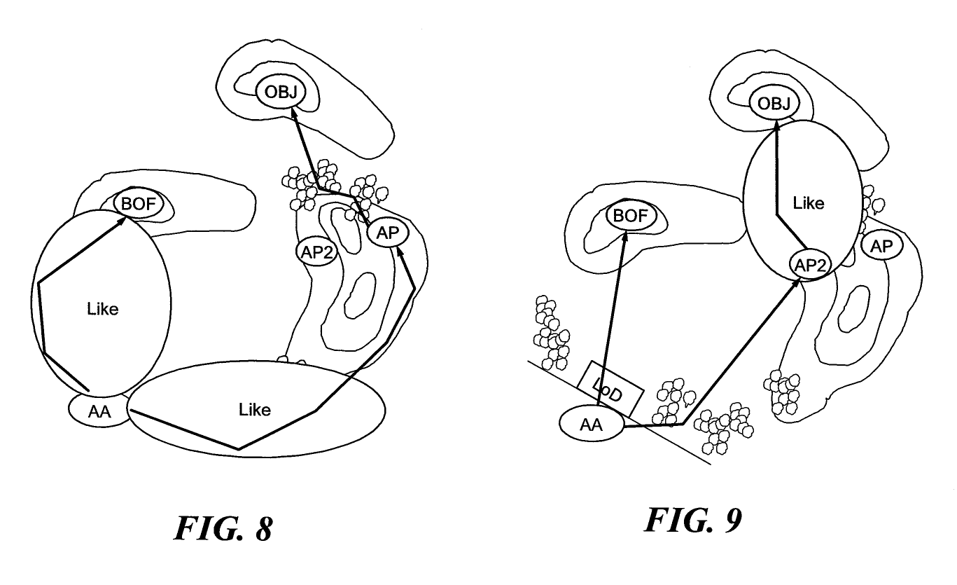

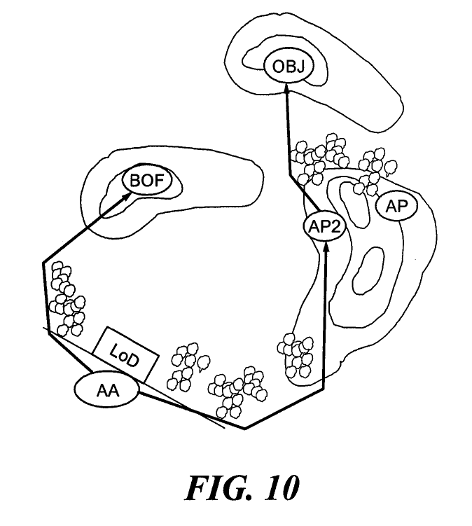

FIGS. 4-10 show an example of the usefulness of being able to change metric evaluation weights dynamically during planning, in a military context. In the process, the planner learns that there are situations when the forces should move slowly and stealthily to get in place for the final assault. Once the assault begins, movements become fast and direct. The inputs to the system include the base of fire BOF and two choices for an assault position AP and AP2, along with sufficient descriptors that the situation of a unit in each position can be distinguished. FIG. 4 shows the goal: attack the enemy on objective OBJ from initial assembly area AA; and subgoals: establish a base of fire at BOF for fire support, and do the final attack from one of two assault positions: AP or AP2. A terrain analyzer provides a set of routes (FIG. 5) with risk and speed ratings for each, which provides a variety of ways to move between control measures. FIG. 6 shows a minimum risk plan (i.e., a plan created using action evaluation weights that emphasized the importance of minimizing risk) maximizing cover and concealment from enemy on objective OBJ, taking advantage of trees and ridgelines. FIG. 7 show a minimum time plan (i.e., one that emphasized minimizing time) that makes shortest-path choices to get to BOF and OBJ. FIG. 8 and FIG. 9 show the result of the user expressing preferences on each plan. In FIG. 8 (the minimum risk plan) the user likes slower, less risky route to BOF, and also the start of the low-risk route to the AP. On FIG. 9 (the minimum time plan), the user likes the faster assault route from AP2. FIG. 10 shows the result of a planner incorporating the user preferences of FIG. 8 and FIG. 9 as it replans, creating a plan that includes the best parts of the two original plans.

In the context of the above example, the decision support system (DSS) may employ two planners (alternatively, one planner can create two plans in sequence). It tasks one planner to return a plan for how to capture OBJ while minimizing risk (FIG. 6). It tasks the other planner to plan how to capture OBJ while minimizing time (FIG. 7). Each plan is presented to the user by the DSS. The user expresses preferences about each action, or on sets of actions (FIG. 8), which are stored. A planner is then tasked to create a new plan, influenced by the user preferences (FIG. 9).

The inventive system offers an automated way to solve a multi-objective constraint satisfaction problem with a human in the loop. A common approach to these problems is to evaluate a linear combination of metrics in the form of a weighted sum. But in practice, the function may be non-linear. For example it is important to minimize risk, but only to the extent that it doesn't impact requirements for accomplishing goals on time. In the inventive system, a plan may be created that minimizes each parameter of the metric separately, and the user's preferences about parts of each plans become a non-linear function that is parameterized by types of situations. In the example, the metric to be minimized is a function of risk and time. One plan is constructed using a weight of 1.0 on risk and 0.0 on time. Another plan is constructed using a weight of 0.0 on risk and 1.0 on time. When the user is shown both plans, the user “likes” the actions near the start of the plan that minimized risk exclusively, and the user “likes” the actions near the end of the plan that minimized time. Thus when the planner replans incorporating these user preferences, the resulting plan minimizes risk in the early part of the plan and minimizes time in the later part.

As discussed above, existing solutions have not exploited a symbiotic relationship between a decision support system (DSS) and a planner. Planners often have user interfaces, which may be graphical and may show a lot of data about the plan. While conventional planners may enable users to adjust the inputs to the planner, the inventive embodiments described above enable a user to choose parts of several plans and ask the planner to combine them into a unified plan, or to replan after learning user preferences by observing the user's choices.

Generalizing Feedback

Generalization from experience has been investigated in a field of machine learning known as inductive learning. One type is Explanation Based Learning, which attempts to infer general rules from examples. Another type is Relevance Based Learning, which tries to find the relevance of a set of features to the goal predicate.

The state is represented by literals or facts that describe the current objects in the planning domain. When the user likes a particular action at a particular point in the plan; e.g., move(car3, location24, location35) when plan literals F2, F4, and F7 are true, the system should learn something that will be generally applicable in many situations. Part of the problem is saliency: is it important that all three plan literals are true, or is F7 perhaps not so important?. Saliency is a relatively difficult problem in artificial intelligence that the inventive system deals with in the storage and matching subsystem.

In one embodiment, the system generalizes user feedback and addresses saliency by employing an analogical reasoner, such as the known SAGE (previously disclosed as “SHAAR”), in the user preference database. SAGE finds correspondences between a novel situation (a target) and a known situation (a source). These correspondences may stem from relational symmetries, object similarities, or a combination of the two. SAGE represents objects in a situation in an ontological hierarchy, and can match situations that have similar, but not the same objects. Thus “MechanizedInfantryPlatoon_{—}1_{—}22” may be found to be similar to MechanizedInfantryPlatoon_{—}3_{—}5, because they are both Platoons and MechanizedInfantry. It may also be similar to ArmoredPlatoon_{—}1_{—}12 since both are Platoons, but that should be a more distant match because they are different types of Platoons.

In another aspect of the invention, a system provides a correspondence feature. The planner is given a description of the problem domain, which identifies objects, valid actions they can take under what conditions, how those actions affect the world, and propositions that can be stated about the world. The knowledge repository, e.g., SAGE, is given an ontological description of the objects of interest in the world, which identifies their types and their relationships. When the user indicates a preference in a certain situational context, and the situational context or state is stored in the repository in association with the evaluation weights that produced the action selection about which the user expressed the preference, the user preferences database saves a typed representation of the state. This approach offers generalization capabilities for different problem descriptions within the same domain.

One skilled in the art will note that it is also possible to generalize certain information across domains. The information can be generalized to the extent that the domain descriptions of the domains match.

It is understood that in other embodiments other suitable analogical reasoners can be used. For example, the Fuzzy Attributed Relational Graph (FARG) can represent a state as a fuzzy graph in which nodes tagged with attributes represent the Boolean and numeric facts that describe the situational context. The FARG system has a related technique for storing the graphs and searching for them using a low-complexity algorithm.

Saliency

When the user indicates that an action is ‘good’ in a certain situation, that situation is represented by a number of facts, and the planner does not know which features of the situation are really important. As a trivial example, if the situation is described by three facts such as (fuel_level tankA 30) (at tankB locX) (supplies mortarC munitionHE 10), and the user likes the action that moved tankB to locY, how can the planner know if the status of tankA and mortarC were important? One approach is to look for any correlations between the future actions of tankB and the other units. It is possible that at some future time tankB brings fuel back to tankA.

A situation that is ‘similar’ to one in storage is a state in which the set of facts defining the two states are either identical, or a close match. If the current state and the state in storage were not defined by the same problem specification files, it is likely that specific grounded facts in the state descriptions will differ. However, since an analogical reasoner like SAGE can do an ontological match, and also measure how well the two states actually match, this is the measure of similarity. In an exemplary embodiment of the invention, when a planner chooses an action in a situation similar to one that is already in storage, it merges the two situations by reinforcing those facts that are in common, and reducing the strength of facts that are not in common. Thus each fact in the stored representation has a weighting representing its strength. SAGE can perform this type of re-weighting of parts of a proposition almost as a side-effect to matching.

Feedback Storage and Retrieval

When the user ‘likes’ an action in the sense described above, in a certain situational context, a record is generated in the feedback database to store the weights that were in effect when that part of the plan was generated. The set of facts representing the situational context is augmented with the subgoals that the action supports. Thus each record in the feedback database is a vector of metric weights <w1 w2 . . . wn> indexed by the set of facts and subgoals [F1 F2 . . . Fn, SG1 . . . SGn] that represent the situational context. Given an input vector representing a new situational context, if the system then finds a match it returns the set of weights.

This technique would be most generalizable if inexact matches are possible, within some distance metric of an entry. A match would be returned if it exceeds some threshold of similarity. Either SAGE or FARG can do this type of inexact match.

Using the Feedback Database during Planning

It is possible that one skilled in the art could employ this technique in many different types of planners. The example is a forward search planner, such as FF. The planner main loop progresses the current state (a set of Boolean facts and numeric variables) into the next state by applying one or more of the actions that have their preconditions satisfied in the current state. The planner chooses which action(s) to apply by estimating each action's ability to get closer to solving the goals. Normally a planner uses its statically weighted evaluation function to make its choices. Using the present invention, if the planner finds that the current state is very similar to a state in which the user asserted a preference, the choice can be made using the stored set of weights on the metric function. That is, in each situational context the planner encounters in its main loop, it presents that context to the knowledge base to see if there is a situation that is very similar. The threshold for similarity will likely be different for different domains. One skilled in the art can adjust this threshold so that the system returns appropriately similar states. When a similar state is found, the associated weights are retrieved and are used to weight the evaluation function. This weighting will cause the planner to choose an action that is more likely to be one that the user would have chosen. When that situational context changes, the weightings are reset to defaults.

While the invention is primarily shown and described in conjunction with planners and planning techniques for military applications, it is understood that the invention is applicable to a wide variety of applications in which it is desirable to compare multiple plans and/or incorporate user feedback.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
generating a first plan having a series of actions;
outputting the plan to enable a user to perceive the plan;
receiving feedback from the user on the plan;
generating a revised plan based upon the first plan and the feedback from the user.

2. The method according to claim 1, wherein the user feedback includes a portion of a plan selected by the user.

3. The method according to claim 2, wherein the selected portion corresponds to a portion of the plan liked by the user for at least one of the series of actions.

4. The method according to claim 1, wherein the user feedback is stored for use in generating subsequent plans.

5. The method according to claim 1, wherein the user feedback records are indexed by a function of a list of facts that describe a situation.

6. The method according to claim 5, wherein the index further includes an incorporated list of subgoals.

7. The method according to claim 5, wherein the records include a list of weights for parameters of an evaluation function for rating actions.

8. The method according to claim 1, wherein the revised plan is generated by using weights associated with a state of the plan that matches a user feedback record.

9. A method, comprising:
generating first and second plans;
outputting the first and second plans to enable a user to perceive the first and second plans;
processing user feedback on the first and second plans; and
combining the first and second plans to provide a revised plan based upon the user feedback.

10. The method according to claim 9, further including dynamically altering weights of an evaluation function to incorporate the user feedback in the revised plan.

11. The method according to claim 10, further including generating the first plan by tasking a planner with a set of weights for an evaluation function and problem specification files.

12. The method according to claim 9, wherein the weights are multipliers in a linear combination of factors used by the evaluation function when rating an action for incorporation into the revised plan.

13. The method according to claim 9, wherein the first and second plans are generated by using first and second weightings that are different.

14. The method according to claim 13, wherein the first weightings are obtained from a user history file.

15. The method according to claim 13, wherein the first weightings are created randomly.

16. An article, comprising:
a storage medium having stored thereon instructions that when executed by a machine result in the following:
generating a first plan having a series of actions;
outputting the first plan to enable a user to perceive the plan;
receiving feedback from the user on the first plan;
generating a revised plan based upon the first plan and the feedback from the user.

17. The article according to claim 16, wherein the user feedback includes a portion of a first plan selected by the user.

18. The article according to claim 16, wherein the actions have associated records indexed by a function of a list of facts that describe a situation and the subgoals that have not been achieved in the situation.

19. The article according to claim 18, further including instructions for generating a second plan,
processing user feedback on the first and second plans; and
combining the first and second plans to provide a revised plan based upon the user feedback.

20. The article according to claim 16, further including instructions for dynamically altering weights of an evaluation function to incorporate the user feedback in the revised plan.
